(19) United States
(12) Patent Application Publication
(10) Pub. No.: US 2002/0095368 A1
(43) Pub. Date: Jul. 18, 2002

(54) Systems and methods for trading intellectual property

(76) Inventor: Bao Tran, (US)

Correspondence Address: BAO TRAN, 3103 GLEN ALTO COURT, SAN JOSE, CA, 95148, US

(21) Appl. No.: 09/842,599

(22) Filed: Apr. 25, 2001

Related U.S. Application Data
(60) Provisional application No. 60/200,962, filed on May 1, 2000.
(60) Provisional application No. 60/185,644, filed on Feb. 29, 2000.

(51) Int. Cl. G06F 17/60

(52) U.S. Cl. 705/37

(57) ABSTRACT

A system supports trading of intellectual property (IP) with a user interface to accept a request to trade an IP asset; and a database coupled to the user interface to store data associated with one or more IP assets, the database supporting the trading of the IP asset.

This application claims priority from Provisional Application No. 60/200,962, filed on May 1, 2000 and Application Ser. No. 09/792,828 filed on Feb. 24, 2001, which claims priority from Provisional Application No. 60/185,644 filed on Feb. 29, 2000, the contents of which are incorporated by reference.

### BACKGROUND

The present invention relates to systems and methods for trading intellectual property.

To compete more effectively at Internet speed, organizations are delivering relevant information and providing increasingly sophisticated and time-sensitive services to a rapidly expanding audience, including employees, customers, suppliers and partners both inside and outside the traditional enterprise. Many organizations have extended their business over the Internet to directly reach a large number of geographically dispersed end-users. Due to the speed at which new ideas and concepts propagate over the Internet, these e-business initiatives require greatly shortened the time necessary to procure and to perfect the protection of new intellectual assets arising from these activities. Intellectual assets includes, among others, the know-how, knowledge and skills that resides within a company. It is often the invisible force that allows one company to succeed over its competitors. However, since these assets are intangible, they are difficult to account for. One way to capture intellectual assets is to file applications with national patent, trademark or copyright offices to cover these assets. With certain IPs such as patents, the process for procuring these IP assets are expensive and time-consuming.

Once procured, many IP assets lie unused due to the expense of identifying infringing products and/or efforts required to negotiate licenses. To realize the benefits of properly managing the IP assets, a company can supplement revenue through full utilization of the latent potential of its technology portfolio. By mining these corporate assets, significant revenues can be generated. One way to mine these assets is to license other companies. However, such activities typically require a team of reverse-engineering specialists, negotiators and lawyers, an overhead that most companies cannot afford. Additionally, when a company contacts other members of their own industry about licensing, their attempts are viewed with suspicion, since a failed negotiation can be the precursor to litigation.

Yet another way to mine the IP assets is to trade, buy or sell them. Although the Internet has provided companies and individuals with an abundance of information such as patent databases and related information, the sheer volume of data makes it difficult to locate and navigate the information needed to procure and trade IP assets. Further, to date, the finding of potential buyers of a particular IP asset has been a hit-or-miss process. Because the process relies heavily on personal networking, it takes a long time to find a buyer for each available technology. Moreover, companies rarely look beyond their own industry to market technologies. As a result, the current practice yields only a few deals per company annually due to high transaction costs.

### SUMMARY

Systems and methods cost-effectively are disclosed to facilitate and enhance the licensing and trading of IP assets. The system supports purchasing or selling of intellectual property related products and services with a computerized bid, auction and sale system over a network such as the Internet. The techniques provide IP owners with access to an open market for trading IP. The techniques support a service-based auction network of branded, online auctions to individuals, businesses, or business units. The techniques offer a quick-to-market, flexible business model that can be customized to fit the IP needs of any industry and target technology.

In one aspect, a system supports trading of intellectual property (IP) with a user interface to accept a request to trade an IP asset; and a database coupled to the user interface to store data associated with one or more IP assets, the database supporting the trading of the IP asset.

Implementations of the system can include one or more of the following. The system offers one of more of the following: a trade IP user interface to accept a request to trade an IP asset; a buy IP user interface to accept a request to buy an IP asset; a sell IP user interface to accept a request to sell an IP asset; a register IP user interface to accept a request to register an IP asset; an appraise IP user interface to accept a request to appraise an IP asset; and an escrow IP user interface to accept a request to place an IP into escrow service. The system can provide an IP chat-room. The system can provide a network adapted to electronically link IP specialists to provide value added services to the patent application. The system can match IP specialists such as attorneys, draftsmen, IP marketers and inventors on request. The IP specialists can be paid on a commission basis. An automated patent drafting system can be used to generate a patent application having a required sequence. The system can provide an online platform for selling and buying patentable ideas or pending patent applications and where parties can list and search for applications that are about to be abandoned. The network is the Internet and wherein clients access the system using a browser. A patent information management (PIM) system can be used to display information for a user to manage the user's IP and to communicate with other users relating to the IP. The PIM provides information on pending activities relating to an IP asset and wherein the user can drill down to get additional information on the IP asset.

On-line trading is done through a network-based community in which buyers and sellers are brought together in an efficient format to buy and sell intellectual property and other assets. The system permits sellers to list assets for sale, buyers to bid on assets of interest and all users to browse through listed items in a fully-automated, topically-arranged, intuitive and easy-to-use online service that is available 24-hours-a-day, seven-days-a-week. The system overcomes the inefficiencies associated with traditional person-to-person trading by facilitating buyers and sellers meeting, listing items for sale, exchanging information, interacting with each other and, ultimately, consummating transactions. Through such a trading place, buyers can access a significantly broader selection of assets to purchase and sellers have the opportunity to sell their assets efficiently to a broader base of buyers. The techniques support real time and interactive auctions that allows bidders place bids in real time and compete with other bidders around the world using the Internet. The techniques allow customer bids to be automatically increased as necessary up to the maximum amount specified, so bids can be raised and auctions won even when bidders are away from their computers. In one aspect, the techniques provide a single window to a user's most commonly used desktop information. The window provides a portal that helps the user protect new ideas or concepts in an economical, efficient and fast manner by providing the user with access to a network of IP lawyers for assistance in finalizing the applications. The portal also links the user with IP related businesses such as those who specialize in trading or mediating IP related issues. The portal also provides access to non-IP resources, including venture capitalists and analysts who track evolving competition and market places. The portal remains with users the entire time they are online and can automatically update the users on any competing products or any new patents or trademarks granted in their areas of interest. Once users are logged-in, the portal remains in full view throughout the session, including when they are waiting for pages to download, navigating the Internet and even engaging in non-browsing activities such as sending or receiving e-mail.

The constant visibility of the portal allows advertisements to be displayed for a predetermined period of time. Thus, the techniques provide Internet advertisers and direct marketers a number of advantages in realizing the full potential of online advertising. The techniques capture the users' profiles regarding their areas of interests, current occupations, company affiliations, demographic information (such as age, gender, income, geographic location and personal interests), and the users' behavior when they are online with the system. As a result, the system can deliver targeted advertisements based on information provided by users, actual Web sites visited, Web-site being viewed, or a combination of this information, and measure their effectiveness. Thus, the system allows online advertisers to successfully target their audiences, largely due to the availability of a precise demographic and navigation data on users. The system also allows advertisers to receive real-time feedback and capitalize on other potential advantages of online advertising. The techniques provide an easy and efficient method for generating traffic to Web sites, strengthening customer relationships, which ultimately increases revenues on unused IP assets.

In another aspect, the system provides an online platform for selling and buying ideas without patent protection or ideas with pending patent applications that otherwise are ready to be abandoned. The system allows parties to list and search for applications that are about to be abandoned simply because the inventors or owners of the application do not have financial resources to pursue the prosecution of these applications for financial or other reasons. The system provides a win-win solution for the inventors and for investors who see potential revenue opportunities.

Other advantages and features will be apparent from the following description, including the drawings and claims.

### BRIEF DESCRIPTION OF THE DRAWINGS

FIG. 1 is a diagram of a system for processing intellectual property assets.

### DESCRIPTION

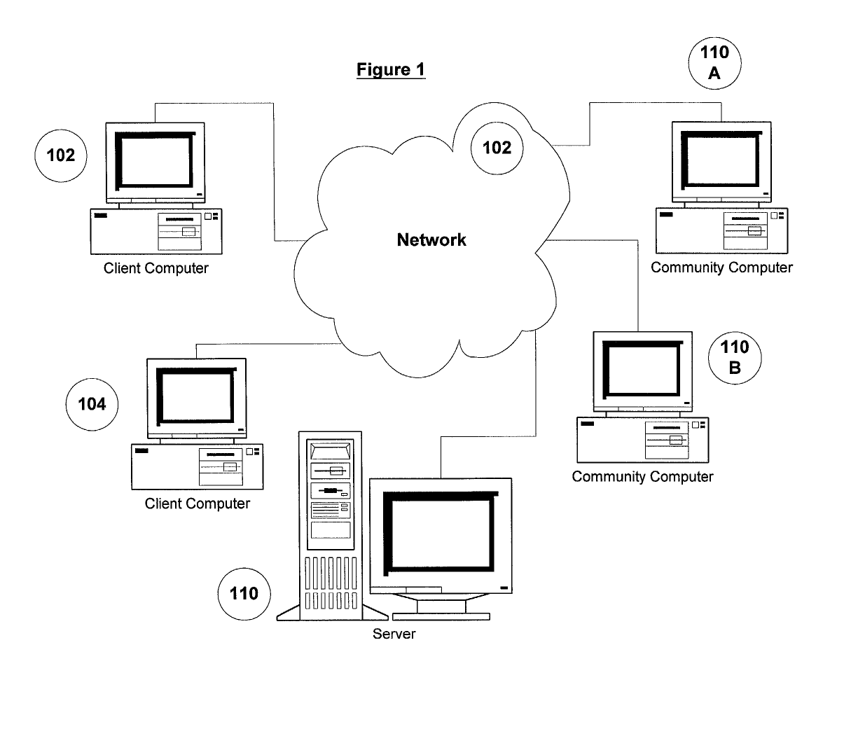

FIG. 1 shows an environment for processing intellectual property assets. A server 100 is connected to a network 102 such as the Internet. One or more client workstations 104-106 are also connected to the network 102. Additionally, an Internet community 110 with one or more service providers, manufacturers, or marketers are connected to the network 102 and can communicate directly with users of the client workstations 104-106 or indirectly through the server 100. The Internet community 110 provides the client workstations 104-106 with access to a network of IP specialists. For example, members of the Internet community 110 can include attorneys who can add value to the preparation, the prosecution, and the enforcement of the resulting IP rights. Additionally, the Internet community 110 also provides access to a variety of supporting members such as prior art search firms and patent delivery firms, among others. Additionally, one or more patent granting authorities 112 such as the US PTO, the Japanese Patent Office, and the European Patent Office, among others, can be connected to the network 102. The patent granting authorities 112 can receive electronic patent application submissions and can also provide various resources aiding patent applicants.

Although the server 100 can be an individual server, the server 100 can also be a cluster of redundant servers. Such a cluster can provide automatic data failover, protecting against both hardware and software faults. In this environment, a plurality of servers provides resources independent of each other until one of the servers fails. Each server can continuously monitor other servers. When one of the servers is unable to respond, the failover process begins. The surviving server acquires the shared drives and volumes of the failed server and mounts the volumes contained on the shared drives. Applications that use the shared drives can also be started on the surviving server after the failover. As soon as the failed server is booted up and the communication between servers indicates that the server is ready to own its shared drives, the servers automatically start the recovery process. Additionally, a server farm can be used. Network requests and server load conditions can be tracked in real time by the server farm controller, and the request can be distributed across the farm of servers to optimize responsiveness and system capacity. When necessary, the farm can automatically and transparently place additional server capacity in service as traffic load increases. The server 100 can also be protected by a firewall. When the firewall receives a network packet from the network 102, it determines whether the transmission is authorized. If so, the firewall examines the header within the packet to determine what encryption algorithm was used to encrypt the packet. Using this algorithm and a secret key, the firewall decrypts the data and addresses of the source and destination firewalls and sends the data to the server 100. If both the source and destination are firewalls, the only addresses visible (i.e., unencrypted) on the network are those of the firewall. The addresses of computers on the internal networks, and, hence, the internal network topology, are hidden. This is called “virtual private networking” (VPN).

The server 100 supports an intellectual property portal that provides a single point of integration, access, and navigation through the multiple enterprise systems and information sources facing knowledge workers operating the client workstations 104-106. In an exemplary user interface to support IP asset trading, the user interface is a web-based user interface. The user interface allows a user to sign-on or sign-off the system. The user interface also provides the user with a plurality of operating options accessible through clickable buttons, including “Buy IP Asset”; “Sell IP Asset”; “Register IP Asset”; “Appraise IP Asset”; “IP Escrow Service”; “Refer a Buyer”; and “IP Chat” buttons. Additionally, the user can access his or her specific interest by accessing a “Your Account” button, a “Your Listings” button, and a “Your Offers” button. Other buttons allow the user to utilize ancillary services such as “Trademark Search” button and “IP Monitoring” buttons.

The operations of exemplary buttons are discussed next. First, the Buy button allows a user to bid on a particular asset. In this embodiment, there are no fees charged to the buyer for this service and the seller pays fees. A user can simply search for desired IP assets and submit an offer using an interactive form. Upon receiving an offer, the system forwards it to the seller and notifies the buying party whether the offer has been accepted, rejected, or if there is a counteroffer. If the offer is accepted, the buyer will be mailed a purchase contract and detailed escrow instructions to sign, similar to those used in a real estate or business opportunity transaction.

For trademark applications, another embodiment can walk the user through whether he or she wishes to generate use-based applications or intent-to-use (ITU) applications, which are available if one has not yet used the mark on goods. The system prompts the user to list all the goods with which the mark will be used, or has been used. This should be carefully worded to ensure that the registration is not unduly narrowed. The system then requests a description of how the mark is used. A trademark must be used on (or in connection with) the actual goods—advertising is not sufficient use. The system can ask if the mark is a composite mark (such as a logo plus words), then the system presents the user with a choice of registering the word mark alone, the word/logo combination, or the logo alone. The system also guides the user with the selection of specimens with a use application. These are actual labels, tags, or packaging. The system can then suggest alternatives such as photographs that can be sent instead of specimens when the specimen is not fiat, or when it is too large.

The Appraise button provides an electronic valuation module to estimate the value of the IP assets. Factors evaluated include term of duration of rights; status of applications made in foreign countries and fights approved there; litigation with third parties; licensing status; technical nature of invention (three categories: basic technology, vastly improved technology and marginally improved technology); related patents; technical dominance of the IP asset, as judged by degree to which invention has been developed into a superior concept, extent and clarity of specification; clarity of range of technology if there is something unclear in the range of technology for which fights have been formed or there is concern over the occurrence of infringement-related disputes; relationship to use of IP rights possessed by third party; technical superiority to substitute technology; extent to which invention has been proven in real use; necessity of additional development for commercialization; markets for commercialization; transfer and distribution potential; inventors (or right-holders)'s intent to engage in continual research and development and the possibility of applying the results; potential restrictions on the places that it can be licensed to (such as limits on the term and region of implementation); the right-holder's ability to exercise its rights against infringing parties; the possibility that rights will be invalidated, canceled, or limited; the business potential of the invention; the possibility that substitute technology for the invention will be developed; the potential for competing or substitute products will appear; the ease that imitation products be easily manufactured; the ease of detecting infringing products; the size of the market, the market scale, the market share that is acquirable and the time frame for acquiring the targeted market share; the life span for the product's market; the price that a customer is willing to pay for the value generated by the relevant patent right; and the sustainability of the profit.

The sale of the IP asset can be facilitated using the system's brokerage and escrow service. The Escrow button allows a buyer and seller to have a neutral third party watch over the title transfer process. Through this service, a seller provides the systems with details of the transaction: the asset, selling price, current and future owners, and email addresses in an online form. Next, after confirming ownership registration and transaction details with each party via e-mail, the system generates a purchase agreement and escrow instructions for both parties to the transaction to sign. After the documentation is complete and returned to the system, a separate bank account is opened for this transaction, and the buyer is instructed to remit the funds to this account. The system works with the buyer and seller and a government agency such as a patent, trademark, or copyright office to properly affect the transfer of the asset. After the successful transfer, the funds are released from escrow to the seller (made payable to the registered owner), less transfer expenses. Typically, the system assumes that the seller pays the transfer fee unless otherwise instructed.

The Referral button allows a user to refer another company with potential assets to trade. If the trade occurs, the referring user gets a predetermined percentage of the transaction. This button encourages people to match parties together. The Chat button allows a user to chat with other users of the system on relevant topics such as IP trading. The portal supports services that are transaction driven. Once such service is advertising: each time the user accesses the portal, the client workstation 104 or 106 downloads information from the server 100. The information can contain commercial messages/links or can contain downloadable software. Based on data collected on users, advertisers may selectively broadcast messages to users. Messages can be sent through banner advertisements, which are images displayed in a window of the portal. A user can click on the image and be routed to an advertiser's Web-site. Advertisers pay for the number of advertisements displayed, the number of times users click on advertisements, or based on other criteria. Alternatively, the portal supports sponsorship programs, which involve providing an advertiser the right to be displayed on the face of the port or on a drop down menu for a specified period of time, usually one year or less. The portal also supports performance-based arrangements whose payments are dependent on the success of an advertising campaign, which may be measured by the number of times users visit a Web-site, purchase products or register for services. The portal can refer users to advertisers' Web-sites when they log on to the portal.

Yet another service supported by the portal is on-line trading of IP assets. By communicating through a wide area network such as the Internet, the portal supports a network-based community in which buyers and sellers are brought together in an efficient format to buy and sell intellectual property and other assets. The portal permits sellers to list assets for sale, buyers to bid on assets of interest and all users to browse through listed items in a fully-automated, topically-arranged, intuitive and easy-to-use online service that is available 24-hours-a-day, seven-days-a-week. Through such an IP trading portal, IP buyers can access a significantly broader selection of IP assets to purchase and sellers have the opportunity to sell their IP assets efficiently to a broader base of buyers. The portal overcomes the inefficiencies associated with traditional person-to-person trading by facilitating buyers and sellers meeting, listing items for sale, exchanging information, interacting with each other and, ultimately, consummating transactions. Additionally, the portal offers forums providing focused articles, valuable insights, questions and answers, and value-added information about seed and venture financing and startup related issues, including accounting and consulting, commercial banking, insurance, law, and venture capital. The portal can connect savvy Internet investors with IP owners. By having access to the member's IP interests, the portal can provide pre-screened, high-quality investment opportunities that match the investor's identified interests. The portal thus finds and adds value to good deals, allows investors to invest from seed financing right through to the IPO, and facilitates the hand off to top tier underwriters for IPO. Additionally, members of the portal have access to a broad community of investors focused on the cutting edge of high technology, enabling them to work together as they identify and qualify investment opportunities for IP or other corporate assets.

Other services can be supported as well. For example, a user can rent space on the server to enable him/her to download application software (applets) and/or data—anytime and anywhere. By off-loading the storage on the server, the user minimizes the memory required on the client workstation 104-106, thus enabling complex operations to run on minimal computers such as handheld computers and yet still ensures that he/she can access the application and related information anywhere anytime. Another service is On-line Software Distribution/Rental Service. The portal can distribute its software and other software companies from its server. Additionally, the portal can rent the software so that the user pays only for the actual usage of the software. After each use, the application is erased and will be reloaded when next needed, after paying another transaction usage fee. When a user enters the portal for the first time, the portal presents the user with a simple form to collect basic information about the user, such as names and email addresses. After the user completes the form, he will be shown a legal agreement that he can sign online by clicking a button “Accept.” Alternatively, the user can request a copy of the statement to be downloaded or mailed to him by clicking “Mail Agreement”. The Mail Agreement affords the user with an opportunity to review the details of the agreement with a lawyer if necessary.

After the user signs the agreement by clicking the “Accept” button, he or she will be given a username and password and a registration identification, all of which will be mailed to him at the e-mail address entered in the registration form. The user will also be emailed a welcome package with introductory information about Intellectual Property. After the user signs in for the first time, he will be guided to create a personal profile. The profile tracks the user's interests in various Intellectual Property News, Intellectual Property Laws, Seminars and Conferences, Network of Other People with similar interests, Intellectual Property Auctions & Exchanges, Intellectual Property Lawyers, Intellectual Property Businesses Intellectual Property Mediators between two companies contesting the same IP subject matter, Intellectual Property Forms (Non-disclosures, for example), Patent/Trademark/Copyright Updates and Market Place updates. Though all the services are available to all on the portal, this will personalize his areas of interest and send updates to his desktop directly. The portal can create personalized pages for members by dynamically serving-up the content to each user utilizing dynamic HTML, among others.

Once the user completes the personal profile, he will be prompted to download client software called an “intellectual property assistant” (assistant). The software runs constantly on the user's desktop and connects to the portal whenever the user connects to the Internet. The assistant process is hidden from the desktop process list so that the assistant process cannot be accidentally “killed” or removed by accident. The user can configure this assistant to suite his/her needs. The assistant will also allow the user to have a CHAT/Online Conference with other users registered with the portal.

After connecting to the portal, the assistant checks for the latest updates in his areas of Interest and show them in a small window at the bottom left portion of the screen. The client software performs multiple tasks, including establishing a connection to the portal; capturing demographic information; authenticating a user via a user ID and password; tracking Web-sites visited; managing the display of advertising banners; targeting advertising based on Web-sites visited and on keyword search; logging the number of times an ad was shown and the number of times an ad was clicked on; monitoring the quality of the online session including dial-up and network errors; providing a mechanism for customer feedback; short-cut buttons to content sites; and an information ticker for stocks, sports and news; and a new message indicator.

When the user accesses the portal, a background window is shown on his or her computer screen that is always visible while the user is online, regardless of where the user navigates. The window displays advertisements, advertiser-sponsored buttons, icons and drop-down menus. By clicking on items in the background window, users can navigate directly to sites and services such as intellectual property news, intellectual property laws, seminars and conferences, connections to others with similar interests, intellectual property auctions & exchanges, intellectual property lawyers, intellectual property businesses, intellectual property mediators between two companies contesting the same IP subject matter, intellectual property forms such as a non-disclosure agreement, patent/trademark/copyright updates and market place updates. Revenues can be generated by selling advertisements and sponsorships on the background window and by referring users to sponsors' Web-sites. The assistant shows advertisements while its window is visible. If the user clicks on an advertisement or news or related feature, the assistant will automatically launch the browser and take the user to the advertiser's site. The portal incorporates data from multiple sources in multiple formats and organizes it into a single, easy-to-use menu. Information is provided to the public free-of-charge with value added databases and services such as patent drafting assistance available to subscribers who pay a subscription fee. At a first level, the public can use without charge certain information domains in the portal. At a second level, individual inventors, very small companies and academic users can access the patent drafting software when they subscribe to a first plan with a predetermined annual membership fee and a transaction fee charged per patent application. At a third level, companies can access additional resources such as an IP portfolio management system, a docket management system, a licensing management system, and a litigation management system, for example. In this manner, the portal flexibly and cost-effectively serves a variety of needs. Other resources that the portal provides access to include intellectual property traders who mediate between potential licensors and licensees. These traders conduct accurate evaluations of patented technologies as property rights, as well evaluating their market value.

The portal also provides access to a bid, auction and sale system wherein the computer system establishes a virtual showroom which displays the IPs offered for sale and certain other information, such as the offeror's minimum opening bid price and bid cycle data which enables the potential purchaser or customer to view the IP asset, view rating information regarding the IP asset and place a bid or a number of bids to purchase the IP asset.

The portal has access to IP search engines that continuously search the web and identify information that is of interest to its users. These search engines will use the user profiles to search the web and store the results in the user folders. This information is also relayed to the users using the assistant. The portal delivers focused IP contents to interested subscribers and indirectly drives these subscribers and their businesses to innovate.

The portal thus allows users to draft their own applications rapidly and accurately and in a manner that conforms to the requirements of the major national patent offices. Quality in the resulting patent application is achieved by providing an expert system in software that guides members through each step of preparing an application. Speed is achieved by integrating the IP generation process with existing business workflow. When a communication from the patent office is received, the expert system guides the user through the process of responding. Since the member is generating the bulk of the work product, the cost in procuring the IP asset is reduce, while responsiveness is enhanced.

A network of independent patent attorneys can perform value-added pre-filing check to enhance the member's work product, if desired. Information relating to the network of attorneys will be maintained in a searchable database. Thus, members can search by the attorney's specific expertise (legal as well as technical) and by location. Members can then email the selected attorney a question. To prevent conflict issues, the members will be warned that the first question should be couched abstractly so that the invention is not revealed. Further, each attorney in the network automatically observes the applicable conflict rules in his or her jurisdiction before taking on the question. One or more attorneys in the network can respond to the first question to initiate the consultation process, if no conflict exists. The parties can then negotiate fees relating to subsequent questions and/or work. As such, the portal supports a market-based system for getting qualified IP assistance.

The portal generates revenues by providing advertisement space to law firms, attorneys, patent-support businesses and corporations. All business references for business-to-business transactions will be charged a fee depending on the service levels. Moreover, individuals or companies who use the IP trading services to acquire patents will pay membership fees and a percentage of the cost of the traded IP. They can also choose to pay a royalty instead of a one-time cost. By having access to the member's IP interests, the Web site can provide pre-screened, high-quality investment opportunities that match the investor's identified interests. The web site thus finds and adds value to potential deals, allows investors to invest from seed financing right through to the IPO, and facilitates the hand off to top tier underwriters for IPO. Additionally, members have access to a broad community of investors focused on the cutting edge of high technology, enabling them to work together as they identify and qualify investment opportunities for IP or other corporate assets.

In another aspect, the system provides an online platform for selling and buying ideas without patent protection or ideas with pending patent applications that otherwise are ready to be abandoned. The system allows parties to list and search for applications that are about to be abandoned simply because the inventors or owners of the application do not have financial resources to pursue the prosecution of these applications for financial or other reasons. The system provides a win-win solution for the inventors and for investors who see potential revenue opportunities.

A party that is interested in buying, selling, or trading IP can log onto the system of FIG. 1 over a network. The network could be a local area network, wide area network, or global network such as the Internet. When a user wishes to access the system, he logs on using the selected user identification and a password. If the user identification and password are entered correctly, the system validates them and the user can proceed. If an incorrect password or user identification is entered, a message appears and the operator is prompted to re-enter the incorrect term. After a number of unsuccessful attempts, an error message is displayed and the operator is locked out of the system. If the password entered has expired due to the passage of a predetermined number of days, a password expiration screen can be displayed. This screen permits the user to select a new password and then access the system. It is not necessary to wait until a password expires. Rather, passwords can be changed at any time.

After the user signs in for the first time, the user will be guided to create a personal profile. The profile, in conjunction with a history of usage from the user, is used to personalize his areas of interest and send updates to the pages that are presented to the user. The personal profile is stored as a secured personal legal profile. Based on this information, the server 100 can create personalized pages for members by dynamically serving-up the content to each user utilizing dynamic HTML, among others.

For inventors who wish to use the system, the inventor logs-in if he is already registered, and if not, the user registers and logs-in. The user can be prompted to log-in if the user receives an alert from the portal of FIG. 1. The alert can be a message such as voice mail or electronic mail reminding the user of a particular IP event. Once logged-in, the user can perform various operations until the user completes operation. Thus, the process checks whether the user has completed operation. If so, the process exits. Alternatively, the user can perform a number of operations, including uploading documents related to the IP using a secure transmission method. The user can also browse information, including frequently asked questions (FAQs) relating to the protection of the IP asset. The user can also review links on related topics. Additionally, the user can review the status of one or more applications or patents that the user owns. If documents are queued for the user to review, the user can also download documents for review.

The inventor's page is customized for each inventor according to a number of operations. These operations are grouped by tabs, including a status tab, a FAQs tab, an upload tab, a download tab, a links tab, a help tab, a patent process tab, and a contact tab. The information provided in the status tab includes information on the status for prosecution projects or tasks, the status for infringement projects, and the status for IP trading projects. For example, if the user has two patent applications pending, the first application being partially drafted and the second application had been recently filed, a customized page can be displayed when the user clicks on the first application. In this example, the page indicates that a co-inventor has downloaded a version of the draft application for review. The page also provides a button for a detailed view of the revision history for the application. The page also provides a button to allow the user to download the latest version for review.

The inventor page also shows infringement project status. In this example, the user has submitted two patents to the portal for monitoring of infringement. In this example, one message has been received for the sixth patent. The inventor page also shows custom information relating to IP trading. In this example, a licensing agent has been located and the licensing agent has presented a prospectus to a potential buyer.

Licensing agents can have their personalized pages as well. A licensing agent identifies an IP owner as a potential licensor. Next, the licensing agent negotiates with the IP owner for a representation authorization. The licensing agent then runs a conflict check with the portal of FIG. 1 and, if conflict clears, a representative for the portal accepts the engagement with the client. If a license is reached with a licensee, the money received is deposited with a banking affiliate of the portal and the portal takes a percentage of the dollar size of the transaction. Once the transaction clears, the licensing agent is paid a commission by the portal.

Next, custom pages suitable for viewing from an IP professional such as a patent attorney in servicing inventors can be generated. First, a prospective inventor initiates a preliminary discussion with the IP professional to see if the idea is patentable and to check for potential conflicts, for example. Upon a successful discussion, the inventor provides a retainer for the work to be done. Next, the inventor sends a description of the invention to the IP professional through the portal. An initial draft is done by the IP professional or persons supervised by the IP professional who are affiliated with the portal. The draft is iteratively enhanced by the IP professional and the inventor until it is approved by all parties. Thus, the process checks whether final approval has been granted. If not, the draft application is revised as necessary and the inventor's input is sought. If all parties approve the draft as acceptable, the application is filed with a patent authority such as the U.S. patent and Trademark Office or the European Patent Office, for example.

The portal of FIG. 1 can support a collaborative process where a patent attorney or patent agent interacts with an inventor and collects information relating to an invention. A searcher may be used to conduct a prior art search if the inventor wishes to perform such a search. The information on the information and the prior art search, if requested by the inventor, is relayed to domain experts or technical writers to work on. A domain expert is selected based on the technology, and the domain expert reviews the information and sketches a set of proposed claims in conjunction with the patent attorney and the inventor. The domain expert can then write the specification, or can supervise a technical writer to complete the specification. In parallel, a draftsman is engaged to generate formal drawings corresponding to the specification. The first draft is sent to the patent attorney for review, and after editing if necessary, is sent to the inventor for review. One or more revisions to the draft may be collaboratively performed by the patent attorney, the inventor, domain expert, or the technical writer using the portal. The final work product can be filed with the patent office.

An exemplary IP trading process is discussed next. First, an inventor or IP owner registers with the portal. Next, the inventor or IP owner lists one or more IP assets for trading. If the IP asset is patentable, but the inventor has not pursued a patent application, the portal prompts the inventor to provide sufficient information to file a provisional patent application. Once protected, the inventor can list this asset. The listing of the assets includes non-confidential information sufficient for a buyer to evaluate whether the buyer wishes to proceed to perform due diligence on the IP asset. The listing of each asset also includes a self evaluation of the value of the asset.

The self-evaluation process estimates the value of the IP assets. Factors evaluated include term of duration of rights; status of applications made in foreign countries and rights approved there; litigation with third parties; licensing status; technical nature of invention (three categories: basic technology, vastly improved technology and marginally improved technology); related patents; technical dominance of the IP asset, as judged by degree to which invention has been developed into a superior concept, extent and clarity of specification; clarity of range of technology if there is something unclear in the range of technology for which rights have been formed or there is concern over the occurrence of infringement-related disputes; relationship to use of IP rights possessed by third party; technical superiority to substitute technology; extent to which invention has been proven in real use; necessity of additional development for commercialization; markets for commercialization; transfer and distribution potential; inventors (or right-holders)'s intent to engage in continual research and development and the possibility of applying the results; potential restrictions on the places that it can be licensed to (such as limits on the term and region of implementation); the right-holder's ability to exercise its rights against infringing parties; the possibility that rights will be invalidated, canceled, or limited; the business potential of the invention; the possibility that substitute technology for the invention will be developed; the potential for competing or substitute products will appear; the ease that imitation products be easily manufactured; the ease of detecting infringing products; the size of the market, the market scale, the market share that is acquirable and the time frame for acquiring the targeted market share; the life span for the product's market; the price that a customer is willing to pay for the value generated by the relevant patent right; and the sustainability of the profit.

The trading process then broadcasts the trading information, including the ownership and description of each IP asset, through its network of IP affiliates. One or more interested IP affiliates can contact the inventor or IP owner to market the asset. The progress of the IP affiliates are tracked and reported through the portal on a periodic basis.

The process can select an IP affiliate for marketing the IP asset. In this process, upon registration with the portal, the inventor or IP owner is shown a list or a directory of IP affiliates. To narrow the list, the inventor can specify one or more parameters or qualifications that the IP affiliates are required to have. The inventor or IP owner can also interview the prospective IP affiliates to select one representative in case of an exclusive arrangement or a plurality of representatives if desired.

The selected IP affiliate in turn reviews the IP assets and provides recommendations on the licensing terms or trading price, for example. The IP affiliate and the inventor or IP owner also negotiates on the fees and other transactional details as necessary. A contract is signed, and the IP affiliate proceeds with the marketing of the IP asset. The inventor or IP owner is apprised of progress on a periodic basis. The inventor or IP owner may participate in negotiation with potential licensors or buyers of the IP asset. The marketing process is given a finite duration. If time expires, the process can be restarted. Alternatively, if the IP affiliate succeeds in marketing the IP asset, a deal is closed.

The IP owner and the buyer can directly deal with each other with respect to payment and exchange of ownership. Alternatively, the portal provides an escrow service to facilitate the trading of IP assets. Using the escrow service, the IP owner provides the portals with the details of the transaction: IP asset identification, selling price, current and future owners, and email addresses in an online form. After confirming ownership and transaction details with each party via e-mail, the portal sends a Purchase Agreement and escrow instructions for both parties to the transaction to sign. After the documentation is complete and returned to a representative of the portal, a separate bank Account is opened for the transaction, and the buyer is instructed to remit the funds to this account. The buyer and seller then properly affect the title transfer, and funds are released from escrow to the seller. A transfer fee such as a predetermined amount or percentage can be deducted from the funds on behalf of the services of provided by the portal. Typically, the seller pays the transfer fee unless otherwise instructed.

In an exemplary process for marketing an IP asset, as viewed from an IP affiliate's perspective, the IP affiliate registers with the portal and provide credentials, among other information. Next, the process lists the IP affiliate in its directory or list of qualified affiliates after verifying the credential supplied during registration. The affiliate can then be contacted directly by inventors or IP owners, or the affiliate can search for IP assets listed with the portal and contact the owner of the IP asset to represent the owner in marketing the IP asset. Once a party has been identified, the IP affiliate works with the IP owner in developing a marketing plan and prepares marketing collateral. Next, the IP affiliate markets the IP assets, and concludes the transaction by closing a deal or, if time expires, terminates the agreement with the IP owner.

In an exemplary process for marketing an IP asset, viewed from an IP buyer's perspective, the process is initiated when a prospective buyer registers its interest in certain technology with the portal. The buyer can either selects an IP affiliate or is contacted by an IP affiliate for representation. The buyer is then sent periodic updates through a preferred media as to availability.

This invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A system to support trading of intellectual property (IP), comprising:
a user interface to accept a request to trade an IP asset; and
a database coupled to the user interface to store data associated with one or more IP assets, the database supporting the trading of the IP asset.

2. The system of claim 1, further comprising a trade IP user interface to accept a request to trade an IP asset.

3. The system of claim 1, further comprising a buy IP user interface to accept a request to buy an IP asset.

4. The system of claim 1, further comprising a sell IP user interface to accept a request to sell an IP asset.

5. The system of claim 1, further comprising a register IP user interface to accept a request to register an IP asset.

6. The system of claim 1, further comprising an appraise IP user interface to accept a request to appraise an IP asset.

7. The system of claim 1, further comprising an escrow IP user interface to accept a request to place an IP into escrow service.

8. The system of claim 1, further comprising an IP chat-room.

9. The system of claim 1, further comprising a network adapted to electronically link IP specialists to provide value added services to the patent application.

10. The system of claim 9, wherein the system matches IP specialists and inventors on request.

11. The system of claim 1, further comprising a network adapted to electronically link IP attorneys to provide value added services to the patent application.

12. The system of claim 1, further comprising a network adapted to electronically link IP marketers to facilitate IP trading.

13. The system of claim 12, wherein the IP marketers are paid on a commission basis.

14. The system of claim 1, further comprising a network adapted to electronically link support staff including a drafter to provide value added services to the patent application.

15. The system of claim 1, further comprising a patent drafting system to generate a patent application having a required sequence.

16. The system of claim 1, further comprising an online platform for selling and buying patentable ideas or pending patent applications.

17. The system of claim 16, wherein parties can list and search for applications that are about to be abandoned.

18. The system of claim 1, wherein the network is the Internet and wherein clients access the system using a browser.

19. The system of claim 18, further comprising a patent information management (PIM) system to display information for a user to manage the user's IP and to communicate with other users relating to the IP.

20. The system of claim 18, wherein the PIM provides information on pending activities relating to an IP asset and wherein the user can drill down to get additional information on the IP asset.
